(19) United States
(12) Patent Application Publication
(10) Pub. No.: US 2025/0132837 A1
(43) Pub. Date: Apr. 24, 2025

(54) OPTICAL RECEIVING APPARATUS, OPTICAL TRANSMISSION APPARATUS, OPTICAL TRANSMISSION SYSTEM, FEEDBACK METHOD AND ADJUSTMENT METHOD

(71) Applicant: NIPPON TELEGRAPH AND TELEPHONE CORPORATION, Tokyo (JP)

(72) Inventors: Ryo MIYATAKE, Musashino-shi, Tokyo (JP); Toshiaki SHITABA, Musashino-shi, Tokyo (JP); Tomoaki YOSHIDA, Musashino-shi, Tokyo (JP); Yoichi FUKADA, Musashino-shi, Tokyo (JP); Akihiro TANABE, Musashino-shi, Tokyo (JP)

(73) Assignee: NIPPON TELEGRAPH AND TELEPHONE CORPORATION, Tokyo (JP)

(21) Appl. No.: 18/686,829

(22) PCT Filed: Sep. 3, 2021
(86) PCT No.: PCT/JP2021/032394

§ 371 Date: Feb. 26, 2024

(51) Int. Cl. H04B 10/564; H04B 10/079; H04B 10/516; H04B 10/61; H04J 14/00

(52) U.S. Cl. CPC H04B 10/564; H04B 10/0795; H04B 10/5161; H04B 10/612; H04J 14/00

(57) ABSTRACT

An optical reception apparatus includes: a reception detection unit that converts an intensity-modulated optical signal transmitted from an optical transmission apparatus into a frequency modulation signal; a frequency demodulation unit that generates a multi-channel signal by performing demodulation processing on the frequency modulation signal; and a derivation unit that derives, for each channel, a difference between transmission quality and required quality of the intensity-modulated optical signal, and transmits feedback information indicating the difference for each channel to the optical transmission apparatus. The adjustment unit may give priority to a channel having high reception power in the optical reception apparatus and reduce the power of the channel, based on the feedback information. The adjustment unit may give priority to a channel having low transmission quality and increase the power of the channel, based on the feedback information.

### TECHNICAL FIELD

The present invention relates to an optical reception apparatus, an optical transmission apparatus, an optical transmission system, a feedback method, and an adjustment method.

### BACKGROUND ART

An optical transmission system of a scheme (hereinafter, it is referred to as an “FM batch conversion method”) for collectively converting a frequency division multiplexing (FDM) signal into a frequency modulation (FM) signal is introduced into a video signal distribution system (see Non Patent Literatures 1 and 2).

FIG. 16 is a diagram illustrating an example of a configuration of a frequency modulation unit provided in an optical transmission apparatus of the optical transmission system. A frequency modulation unit 110 includes a first laser oscillator 111, a second laser oscillator 112, an addition unit 113, a phase modulator 114, a multiplexing unit 115, and a detection unit 116.

The first laser oscillator 111 generates a laser beam having a narrow line width based on a first oscillation frequency. The first laser oscillator 111 outputs, to the phase modulator 114, a laser beam based on the first oscillation frequency. The second laser oscillator 112 generates a laser beam having a narrow line width based on a second oscillation frequency. The second laser oscillator 112 outputs, to the multiplexing unit 115, a laser beam based on the second oscillation frequency.

A video signal (CATV signal) of cable television broadcasting and a video signal (“BS/CS right-handed IF signal”+“BS/CS left-handed IF signal”) of satellite broadcasting are input to the addition unit 113 as frequency division multiplexing signals from a head end apparatus (not shown). The addition unit 113 generates a multi-channel signal (multi-channel video signal) by adding the video signal of the cable television broadcasting and the video signal of the satellite broadcasting. The addition unit 113 outputs the multi-channel signal to the phase modulator 114.

The phase modulator 114 generates a phase-modulated optical signal using the multi-channel signal by using the laser beam based on the first oscillation frequency. The phase-modulated optical signal is input into the multiplexing unit 115 from the phase modulator 114. Moreover, a laser beam based on the second oscillation frequency is input into the multiplexing unit 115 from the second laser oscillator 112.

The multiplexing unit 115 multiplexes the phase-modulated optical signal and the laser beam based on the second oscillation frequency. The detection unit 116 executes batch reception processing (optical heterodyne detection) on the multiplexed optical signal by using the photodiode. Thus, the detection unit 116 generates a frequency modulation signal (FM signal).

The intensity modulator (not shown) executes intensity modulation on a laser beam for transmission in accordance with a frequency modulation signal. As a result, the intensity modulator generates an intensity-modulated optical signal by using a laser beam for transmission. The intensity modulator transmits an intensity-modulated optical signal to a video-optical line terminal (V-OLT) (not shown). The optical reception apparatus receives the multi-channel signal transmitted in this manner from the V-OLT.

### CITATION LIST

### Non Patent Literature

Non Patent Literature 1: Toshiaki shitaba, and four others, “A study on wideband RF signal transmission system using FM conversion method by all channel phase modulation”, 2021 IEICE General Conference
Non Patent Literature 2: Toshiaki shitaba and two others, “Optical Video Transmission Technique using FM conversion”, IEICE Technical Report CS2019-84 IE2019-64 (2019-12)

### SUMMARY OF INVENTION

### Technical Problem

The optical transmission apparatus transmits a multi-channel signal with fixed transmission power for each channel (frequency) regardless of whether the transmission quality satisfies the required quality in the optical reception apparatus. Here, since the required quality differs for each channel, whether or not the transmission quality satisfies the required quality differs for each channel.

Therefore, the total transmission power of the multi-channel signal may be increased so that the transmission quality satisfies the required quality in all the channels of the multi-channel signal. However, in a case where an increase in the total transmission power of the multi-channel signal is suppressed, there is a case where the transmission quality of the multi-channel signal cannot be improved.

In view of the above circumstances, an object of the present invention is to provide an optical reception apparatus, an optical transmission apparatus, an optical transmission system, a feedback method, and an adjustment method capable of improving transmission quality of a multi-channel signal while suppressing an increase in total transmission power of the multi-channel signal.

### Solution to Problem

An aspect of the present invention is an optical reception apparatus including: a reception detection unit that converts an intensity-modulated optical signal transmitted from an optical transmission apparatus into a frequency modulation signal; a frequency demodulation unit that generates a multi-channel signal by performing demodulation processing on the frequency modulation signal; and a derivation unit that derives, for each channel, a difference between transmission quality and required quality of the intensity-modulated optical signal, and transmits feedback information indicating the difference for each channel to the optical transmission apparatus.

An aspect of the present invention is an optical transmission apparatus including: an adjustment unit that acquires feedback information indicating a difference between transmission quality of an intensity-modulated optical signal and required quality for each channel from an optical reception apparatus, and adjusts power of a multi-channel signal for each channel according to the feedback information; a phase modulator that generates an optical signal phase-modulated according to the multi-channel signal the power of which has been adjusted, by using a laser beam based on a first oscillation frequency; a multiplexing unit that multiplexes laser beam based on a second oscillation frequency and the optical signal; a modulation signal generation unit that generates a frequency modulation signal by performing detection processing on a result of multiplexing the laser beam based on the second oscillation frequency and the optical signal; and an intensity modulator that transmits the intensity-modulated optical signal, according to the frequency modulation signal, to the optical reception apparatus.

An aspect of the present invention is an optical transmission system including: an adjustment unit that acquires feedback information representing a difference between transmission quality of an intensity-modulated optical signal and required quality for each channel from an optical reception apparatus, and adjusts power of a multi-channel signal for each channel according to the feedback information; a phase modulator that generates an optical signal phase-modulated according to the multi-channel signal the power of which has been adjusted, by using a laser beam based on a first oscillation frequency; a multiplexing unit that multiplexes a laser beam based on a second oscillation frequency and the optical signal; a modulation signal generation unit that generates a frequency modulation signal by executing detection processing on a result of multiplexing the laser beam based on the second oscillation frequency and the optical signal; an intensity modulator that transmits the intensity-modulated optical signal according to the frequency modulation signal, to the optical reception apparatus; a reception detection unit that converts the intensity-modulated optical signal transmitted from the intensity modulator into the frequency modulation signal; a frequency demodulation unit that generates the multi-channel signal by performing demodulation processing on the frequency modulation signal; and a derivation unit that derives a difference between transmission quality and required quality of the intensity-modulated optical signal for each channel and transmits the feedback information to the adjustment unit.

An aspect of the present invention is a feedback method performed by an optical reception apparatus, the feedback method including: a reception detection step of converting an intensity-modulated optical signal transmitted from an optical transmission apparatus into a frequency modulation signal; a frequency demodulation step of generating a multi-channel signal by performing demodulation processing on the frequency modulation signal; and a derivation step of deriving, for each channel, a difference between transmission quality and required quality of the intensity-modulated optical signal, and transmitting feedback information indicating the difference for each channel to the optical transmission apparatus.

An aspect of the present invention is an adjustment method performed by an optical transmission apparatus, the adjustment method including: an adjustment step of acquiring feedback information indicating a difference between transmission quality of an intensity-modulated optical signal and required quality for each channel from an optical reception apparatus, and adjusting power of a multi-channel signal for each channel according to the feedback information; a phase modulation step of generating an optical signal phase-modulated according to the multi-channel signal the power of which has been adjusted, by using a laser beam based on a first oscillation frequency; a multiplexing step of multiplexing laser beam based on a second oscillation frequency and the optical signal; a modulation signal generation step of generating a frequency modulation signal by performing detection processing on a result of multiplexing the laser beam based on the second oscillation frequency and the optical signal; and an intensity modulation step of transmitting the intensity-modulated optical signal, according to the frequency modulation signal, to the optical reception apparatus.

### Advantageous Effects of Invention

According to the present invention, an increase in a total transmission power of a multi-channel signal is suppressed, and furthermore, transmission quality of the multi-channel signal can be improved.

### BRIEF DESCRIPTION OF DRAWINGS

FIG. 1 is a diagram illustrating a configuration example of an optical transmission system according to a first embodiment.

FIG. 2 is a diagram illustrating a configuration example of a frequency modulation unit according to the first embodiment.

FIG. 3 is a diagram illustrating an example of a multi-channel signal before level adjustment by an adjustment unit in the first embodiment.

FIG. 4 is a diagram illustrating an example of a multi-channel signal after level adjustment by an adjustment unit in the first embodiment.

FIG. 5 is a diagram illustrating an example of a relationship between a frequency of a multi-channel signal output from a frequency demodulation unit and a carrier-to-noise ratio in the first embodiment.

FIG. 6 is a diagram illustrating an example of a margin of quality regarding a characteristic of a carrier-to-noise ratio in the first embodiment.

FIG. 7 is a diagram illustrating an example of an order of quality improvement in the first embodiment.

FIG. 8 is a diagram illustrating an example of an order of excessive power in the first embodiment.

FIG. 9 is a diagram illustrating an example of a multi-channel signal after level adjustment by an adjustment unit in the first embodiment.

FIG. 10 is a flowchart illustrating an operation example of the optical transmission apparatus according to the first embodiment.

FIG. 11 is a diagram illustrating an example of a margin of quality related to a characteristic of composite second order in a first modification of the first embodiment.

FIG. 12 is a diagram illustrating an example of an order of quality improvement in the first modification of the first embodiment.

FIG. 13 is a diagram illustrating an example of an order of excessive power in the first modification of the first embodiment.

FIG. 14 is a diagram illustrating an example of a multi-channel signal after level adjustment by an adjustment unit in the first modification of the first embodiment.

FIG. 15 is a diagram illustrating a configuration example of an optical transmission system according to a second embodiment.

FIG. 16 is a diagram illustrating an example of a configuration of a frequency modulation unit provided in an optical transmission apparatus of the optical transmission system.

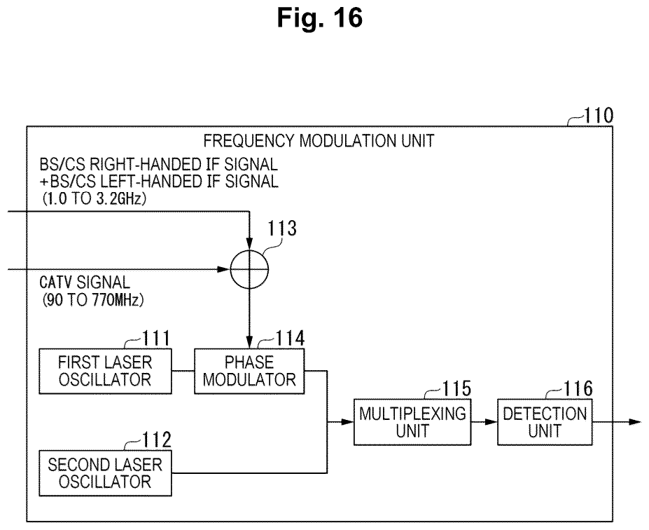

### DESCRIPTION OF EMBODIMENTS

Embodiments of the present invention are described below in detail, with reference to the drawings.

### First Embodiment

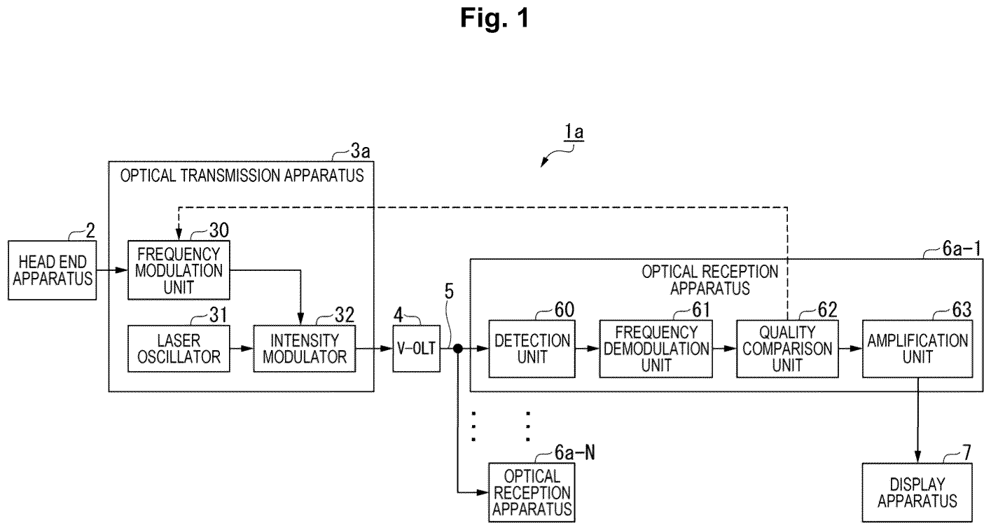

FIG. 1 is a diagram illustrating a configuration example of an optical transmission system 1a. The optical transmission system 1a is a system (optical transmission network) that transmits an optical signal. Hereinafter, as an example, the optical transmission system 1a distributes a video signal (multi-channel signal) by using an optical signal. The video may be a moving image or a still image.

The optical transmission system 1a includes a head end apparatus 2, an optical transmission apparatus 3a, a V-OLT 4, a transmission path 5, N (N is an integer of 1 or more) optical reception apparatuses 6a, and a display apparatus 7.

The optical transmission apparatus 3a refers to feedback information and the like transmitted from the optical reception apparatus 6a. The feedback information (quality feedback information) includes information indicating a margin of transmission quality of a multi-channel signal for each channel (frequency). The feedback information may include information indicating the transmission quality for each channel (frequency).

The required quality of the multi-channel signal is determined in advance by the user, for example. The optical transmission apparatus 3a adjusts (controls) the level of at least one of the voltage and the current to adjust the power of the multi-channel signal before FM collective conversion in the optical transmission apparatus 3a for each channel based on the feedback information. Here, for example, the optical transmission apparatus 3a increases the power of the channel whose transmission quality does not satisfy the required quality (target value). The optical transmission apparatus 3a reduces the power of the channel whose transmission quality is excessive with respect to the required quality, for example, so as to suppress an increase in the total transmission power of the multi-channel signal. That is, the optical transmission apparatus 3a reduces the power of the channel having excessive transmission power (reception power).

As described above, the optical transmission apparatus 3a optimally distributes the power in the total transmission power of the multi-channel signal to each channel. As a result, even when an existing transmission amplifier (not shown) is used in the optical transmission apparatus 3a, an increase in the total transmission power of the multi-channel signal can be suppressed, and the transmission quality of the multi-channel signal can be raised.

The optical transmission apparatus 3a detects a channel to be improved for one or more transmission characteristics and a channel having excessive reception power. The optical transmission apparatus 3a repeats adjustment of the level of at least one of the voltage and the current until a predetermined condition regarding the transmission quality and the level adjustment is satisfied.

The predetermined condition is, for example, a condition that “margins of quality of all channels are equal to or greater than a predetermined threshold value”. The predetermined condition may be, for example, a condition that “each data table is formed in a state immediately before a state in which the transmission power of the channel becomes excessively small due to the adjustment processing (repetition processing) repeatedly performed in the order of excessive power, and the channel registered in the data table in the order of excessive power is registered in the data table in the order of quality improvement”.

The optical transmission apparatus 3a includes a frequency modulation unit 30, a laser oscillator 31, and an intensity modulator 32. The optical reception apparatus 6a includes a detection unit 60, a frequency demodulation unit 61, a quality comparison unit 62, and an amplification unit 63.

The head end apparatus 2 outputs a frequency division multiplexing signal including a video signal (modulation signal) to the optical transmission apparatus 3a. Note that the head end apparatus 2 may output a frequency division multiplexing signal including an audio signal, a data signal (modulation signal), and the like and a video signal to the optical transmission apparatus 3a.

The optical transmission apparatus 3a is an apparatus that transmits an optical signal. The frequency modulation unit 30 executes, for example, optical heterodyne detection processing on an optical signal subjected to phase-modulation in accordance with a video signal. Thus, the frequency modulation unit 30 generates a frequency modulation signal (FM signal).

The laser oscillator 31 generates a laser beam for transmission based on a predetermined oscillation frequency. The intensity modulator 32 is a device that executes intensity modulation on a laser beam for transmission in accordance with a frequency modulation signal. The intensity modulator 32 generates an intensity-modulated optical signal by using a laser beam for transmission. The intensity modulator 32 transmits the intensity-modulated optical signal (optical intensity modulated signal) to the V-OLT 4.

A video-optical line terminal 4 (V-OLT 4) is an optical line terminal. The V-OLT 4 transmits the optical signal intensity-modulated by the intensity modulator 32 to each optical reception apparatus 6a via the transmission path 5. The transmission path 5 transmits an optical signal by using an optical fiber. In the transmission path 5, for example, an optical amplifier (not shown) such as an erbium-doped fiber amplifier (EDFA) and an optical distributor (not shown) are connected in multiple stages. The transmission path 5 uses an optical distributor to distribute an optical signal to each optical reception apparatus 6a from the optical reception apparatus 6a-1 to the optical reception apparatus 6a-N.

The optical reception apparatus 6a is an optical line termination apparatus. The optical line termination apparatus is, for example, a video-optical network unit (V-ONU). The optical line termination apparatus may be, for example, an apparatus (GV-ONU: Gigabit Ethernet (registered trademark) & Video-Optical Network Unit) in which an optical line termination apparatus for video (V-ONU) and a line termination apparatus (GE-PON (Gigabit Ethernet (registered trademark)-Passive Optical Network) ONU) are integrated.

The detection unit 60 (reception detection unit) includes a photodiode. The detection unit 60 converts the optical signal acquired via the transmission path 5 into a frequency modulation signal (electric signal) by detection processing (batch reception processing). The frequency demodulation unit 61 generates a frequency division multiplexing signal (multi-channel signal) including a video signal by executing demodulation processing on the frequency modulation signal. The demodulation processing includes processing of detecting a rise of the frequency modulation signal and processing of detecting a fall of the frequency modulation signal. The difference between the required quality of the frequency division multiplexing signal and the quality (transmission quality) of the transmitted frequency division multiplexing signal can be clarified after the demodulation processing. The frequency demodulation unit 61 outputs the frequency division multiplexing signal to the quality comparison unit 62.

The quality comparison unit 62 transmits the frequency division multiplexing signal (multi-channel signal) to the amplification unit 63. The quality comparison unit 62 compares the transmission quality of the multi-channel signal with the required quality for each channel. The quality comparison unit 62 transmits feedback information (quality feedback information) indicating a difference between the required quality and the transmission quality to the optical transmission apparatus 3a.

A feedback method of the feedback information is not limited to a specific manner. For example, the optical reception apparatus 6a transmits the feedback information to the optical transmission apparatus 3a via a feedback line. For example, when the optical reception apparatus 6 is a “GV-ONU”, the quality comparison unit 62 may transmit the feedback information to the optical transmission apparatus 3a via the transmission path 5 (GE-PON) by using a line termination apparatus (GE-PON ONU).

The amplification unit 63 amplifies the power of the video signal in the frequency division multiplexing signal to a predetermined power.

The display apparatus 7 is an apparatus that displays a video on a screen. The display apparatus 7 acquires, from the amplification unit 63, a frequency division multiplexing signal including a video signal of which power has been adjusted to a predetermined power value. The display apparatus 7 displays the video on the screen in accordance with the video signal in the frequency division multiplexing signal.

Next, a configuration example of the frequency modulation unit 30 will be described.

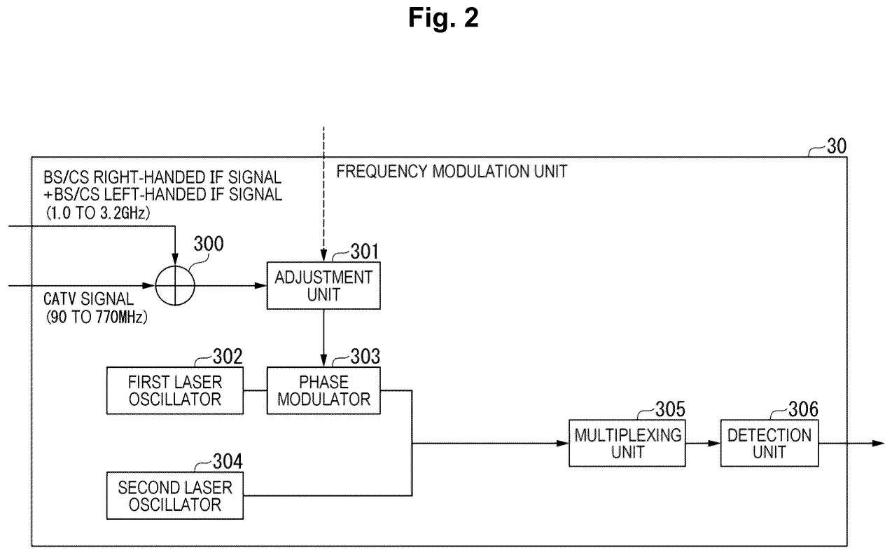

FIG. 2 is a diagram illustrating a configuration example of the frequency modulation unit 30. The frequency modulation unit 30 includes an addition unit 300, an adjustment unit 301, a first laser oscillator 302, M phase modulators 303, a second laser oscillator 304, a multiplexing unit 305, and a detection unit 306.

A frequency division multiplexing signal (multi-channel video signal) including a video signal (modulation signal) is input into the addition unit 300 from the head end apparatus 2 as an input signal. Hereinafter, the video signal is, for example, a video signal of cable television broadcasting and a video signal of satellite broadcasting (intermediate frequency (IF) signal).

A video signal of cable television broadcasting is, for example, a quadrature amplitude modulation (QAM) signal for digital broadcasting, which is included in a band, for example, from 90 MHz to 770 MHz. A video signals of satellite broadcasting is, for example, a broadcast satellite (BS) signal and a communication satellite (CS) signal of 110 degrees included in a band from 1.0 GHz to 2.1 GHZ.

The addition unit 300 adds the video signal of the cable television broadcasting and the video signal of the satellite broadcasting (the signal of the intermediate frequency). The video signal (multi-channel signal) is input to the adjustment unit 301 from the addition unit 300.

The feedback information is input to the adjustment unit 301 from the quality comparison unit 62. The adjustment unit 301 adjusts the power of the video signal based on the feedback information such that the power of the input video signal (multi-channel signal) becomes a predetermined power value for each channel. The adjustment unit 301 outputs a video signal (multi-channel signal) whose power is adjusted for each channel to the phase modulator 303.

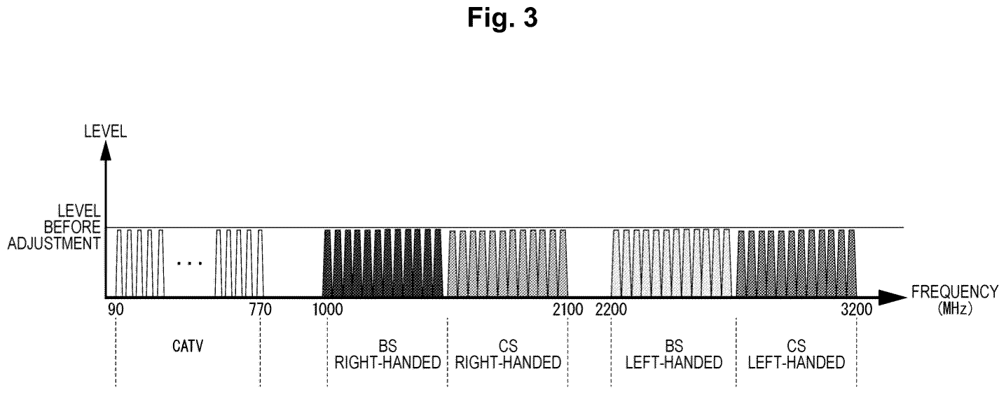

FIG. 3 is a diagram illustrating an example of a multi-channel signal before level adjustment by the adjustment unit 301. The voltage or current “level before adjustment” of the multi-channel signal before the level adjustment is determined in advance for each channel.

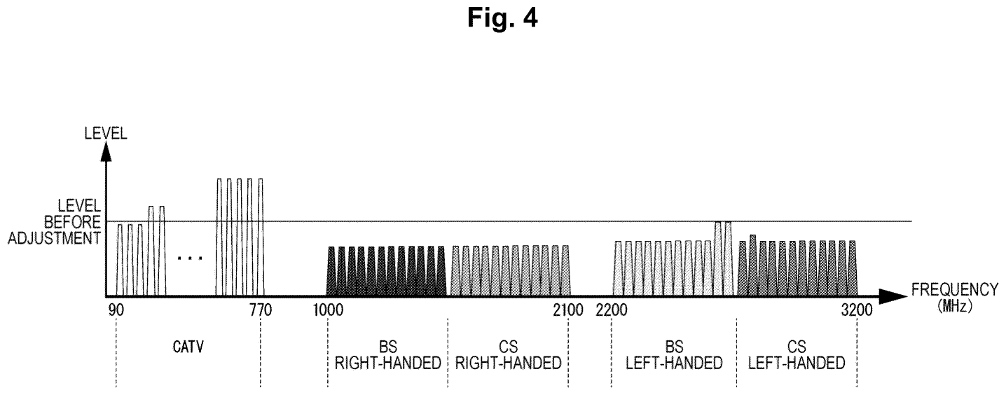

FIG. 4 is a diagram illustrating an example of a multi-channel signal after level adjustment by the adjustment unit 301. For example, the adjustment unit 301 adjusts the level of the voltage or current of the multi-channel signal for each channel so that the total transmission power after the level adjustment does not increase more than the total transmission power before the level adjustment.

Referring back to FIG. 2, description of the exemplary configuration of the frequency modulation unit 30 will be continued. The first laser oscillator 302 is a laser diode. The first laser oscillator 302 generates a laser beam having a narrow line width based on the first oscillation frequency. The first laser oscillator 302 outputs, to the phase modulator 303, a laser beam based on the first oscillation frequency.

A video signal (multi-channel signal) whose voltage or current level is adjusted is input to the phase modulator 303 from the adjustment unit 301. A laser beam based on the first oscillation frequency is input into the phase modulator 303 from the first laser oscillator 302. The phase modulator 303 generates a phase-modulated optical signal in accordance with the video signal, of which the power is adjusted, by using the laser beam based on the first oscillation frequency. The phase modulator 303 outputs, to the multiplexing unit 305, a phase-modulated optical signal in accordance with the video signal of which the power is adjusted.

The second laser oscillator 304 is a laser diode. The second laser oscillator 304 generates a laser beam having a narrow line width based on the second oscillation frequency. The second laser oscillator 304 outputs, to the multiplexing unit 305, a laser beam based on the second oscillation frequency.

The phase-modulated optical signal in accordance with the video signal, of which the power is adjusted, is input into the multiplexing unit 305 from the phase modulator 303. Moreover, a laser beam based on the second oscillation frequency is input into the multiplexing unit 305 from the second laser oscillator 304. The multiplexing unit 305 multiplexes the phase-modulated optical signal in accordance with the video signal and the laser beam based on the second oscillation frequency. The multiplexing unit 305 outputs the multiplexed optical signal to the detection unit 306.

The detection unit 306 includes a photodiode. The detection unit 306 executes batch reception processing (e.g., optical heterodyne detection processing) on the multiplexed optical signal by using the photodiode. As a result, the detection unit 306 (modulation signal generation unit) generates a frequency modulation signal (FM signal). The detection unit 306 outputs a wide-band (e.g., from 500 MHZ to 6 GHz) frequency modulation signal to the intensity modulator 32. That is, the detection unit 306 outputs the multi-channel signal after FM collective conversion to the intensity modulator 32.

Next, an output example of the frequency demodulation unit 61 will be described.

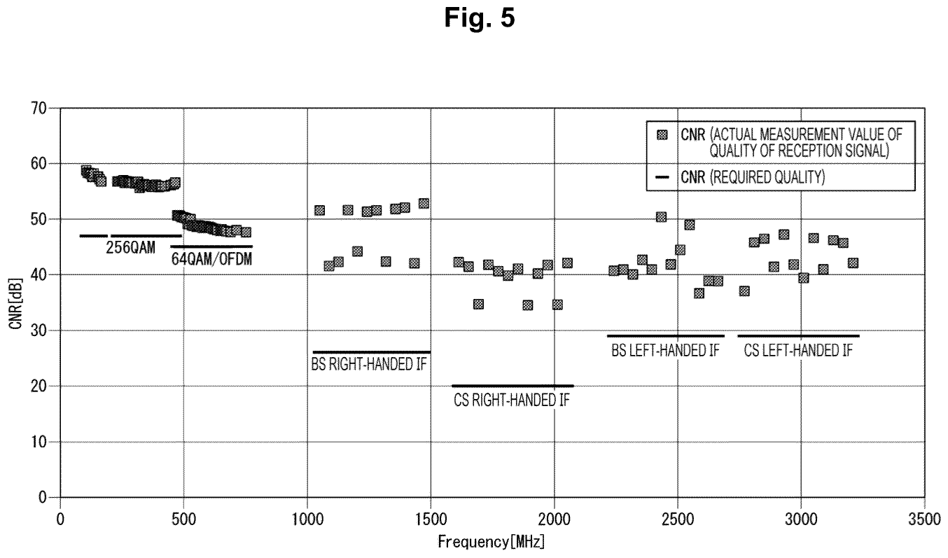

FIG. 5 is a diagram illustrating an example of a relationship between the frequency of the multi-channel signal output from the frequency demodulation unit 61 and a carrier-to-noise ratio (CNR). In FIG. 5, as an example, the transmission quality of the multi-channel signal of “64 QAM/OFDM” is equal to or lower than the required quality (target value of CNR). On the other hand, as an example, the transmission quality of the multi-channel signal of the “BS right-handed IF” is higher than the required quality. That is, as an example, the margin of the transmission quality of the multi-channel signal of the “BS right-handed IF” is large.

The quality comparison unit 62 (derivation unit) derives a difference between the required quality and the quality (transmission quality) of the transmitted multi-channel signal as a margin of quality. The quality comparison unit 62 transmits feedback information indicating a difference between the required quality and the transmission quality (margin of quality) to the frequency modulation unit 30.

Next, an operation example of the frequency modulation unit 30 will be described.

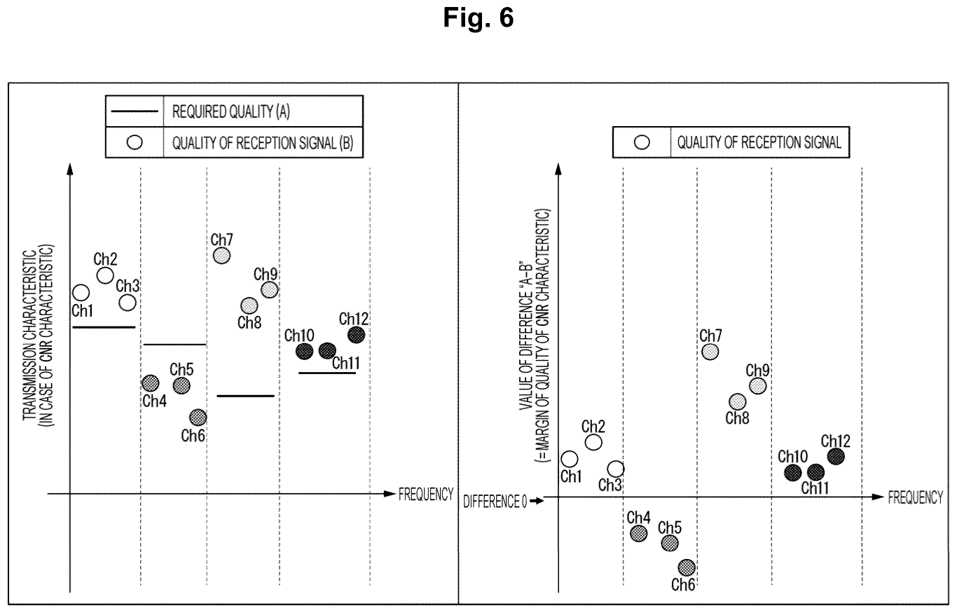

FIG. 6 is a diagram illustrating an example of a margin of quality regarding a characteristic of a carrier-to-noise ratio. On the left side in FIG. 6, the carrier-to-noise ratio representing the transmission characteristics (quality) is represented for each channel “Ch” of the multi-channel signal. The quality comparison unit 62 (derivation unit) derives a difference “A-B” between the required quality “A” and the quality “B” of the received multi-channel signal (reception signal) as a margin of quality for each frequency (channel). On the right side in FIG. 6, the derived difference “A-B” is represented for each channel “Ch” of the multi-channel signal.

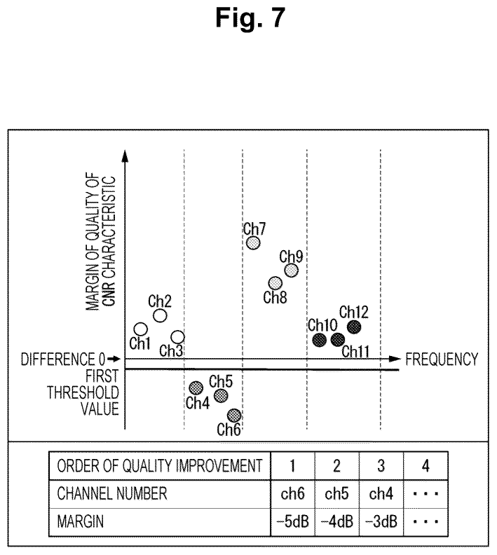

FIG. 7 is a diagram illustrating an example of an order of quality improvement. As a threshold value for detecting (extracting) a channel whose characteristics are to be improved, a first threshold value is determined in advance. The threshold value for detecting a channel whose characteristics are to be improved is an index (standard) representing a design concept of how low the transmission quality is to be improved with respect to the required quality. The first threshold value may be, for example, “0 (dB)”, “5 (dB)”, or “−5 (dB)”. The first threshold value may be a value different for each frequency (channel).

The adjustment unit 301 detects one or more channels whose characteristics need to be improved from all the channels of the multi-channel signal output from the frequency demodulation unit 61. For example, the adjustment unit 301 detects all channels in which the derived difference “A-B” is equal to or less than the first threshold value. As the difference “A-B” falls below the first threshold value, the margin of quality is smaller.

The adjustment unit 301 determines priority order for the channels in the order of necessity of characteristic improvement. For example, the adjustment unit 301 sets a channel with a smaller derived difference “A-B” to a higher priority. That is, the adjustment unit 301 determines a higher priority order for a channel with a smaller margin of quality. The adjustment unit 301 registers, for example, identification information (for example, “Ch6”, “Ch5”, “Ch4”, and the like) of each channel arranged in an order in which characteristic improvement is necessary, in the data table.

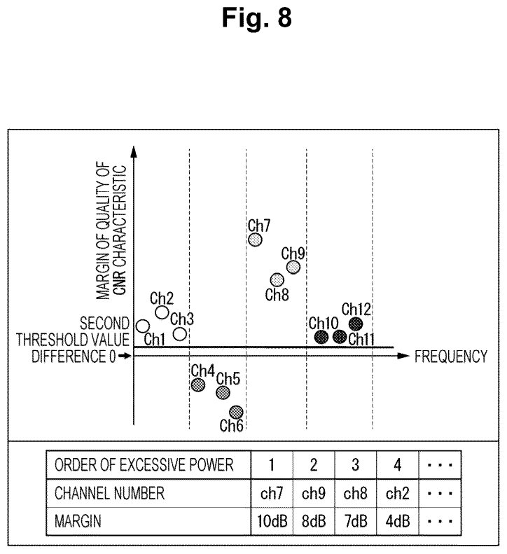

FIG. 8 is a diagram illustrating an example of an order of excessive power. A second threshold value is determined in advance as a threshold value for detecting (extracting) a channel with excessive power. The second threshold value may be, for example, “0 (dB)”, “5 (dB)”, or “−5 (dB)”. The second threshold value may be a value different for each frequency (channel). The adjustment unit 301 detects one or more channels with excessive power from all the channels of the multi-channel signal output from the frequency demodulation unit 61. For example, the adjustment unit 301 detects all channels in which the derived difference “A-B” (margin of quality of CNR characteristics) is equal to or more than the second threshold value.

The adjustment unit 301 determines priority order of channels in order of excessive transmission power (reception power). For example, the adjustment unit 301 sets a channel with a larger derived difference “A-B” to a higher priority. That is, the adjustment unit 301 determines a higher priority order for a channel with a margin of quality of CNR characteristics. The adjustment unit 301 registers, for example, each channel (for example, “Ch7”, “Ch9”, “Ch8”, “Ch2”, and the like) arranged in order of excessive transmission power in the data table.

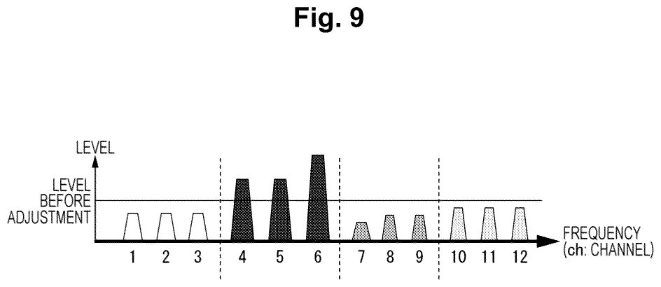

FIG. 9 is a diagram illustrating an example of a multi-channel signal after level adjustment by the adjustment unit 301. A level adjustment amount (power adjustment amount) per step of the characteristic improvement processing (level adjustment processing) is determined in advance as a step amount. The level adjustment amount is, for example, 0.5 (dB).

The adjustment unit 301 increases or decreases the power of the multi-channel signal before the level adjustment by the level adjustment amount each time the level adjustment processing is performed based on the feedback information. For the multi-channel signal input from the addition unit 300, the adjustment unit 301 reduces the power of each channel based on the data table (order of excessive power) illustrated in FIG. 8 with priority given to the channel having the larger reception power in the optical reception apparatus 6a. For the multi-channel signal input from the addition unit 300, the adjustment unit 301 may increase the power of each channel by giving priority to a channel having low transmission quality based on the data table (order of quality improvement) illustrated in FIG. 7.

As a result, as an example, the power of the multi-channel signal from the channel “Ch1” to the channel “Ch3” and the power of the multi-channel signal from the channel “Ch7” to the channel “Ch 12” are smaller than the power before adjustment. As an example, the power of the multi-channel signal from the channel “Ch4” to the channel “Ch6” is larger than the power before adjustment.

Next, an operation example of the optical transmission apparatus 3a will be described.

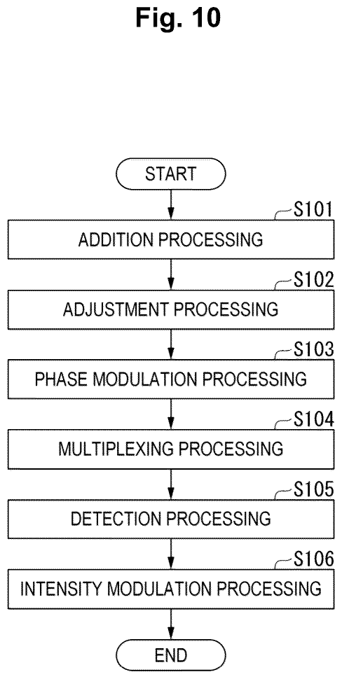

FIG. 10 is a flowchart illustrating an operation example of the optical transmission apparatus 3a. The addition unit 300 adds the video signal of the cable television broadcasting and the video signal of the satellite broadcasting (the signal of the intermediate frequency) (step S101). The adjustment unit 301 adjusts the power of the video signal based on the feedback information such that the power of the input video signal becomes a predetermined power (step S102).

The phase modulator 303 generates a phase-modulated optical signal in accordance with the video signal, of which the power is adjusted, by using the laser beam based on the first oscillation frequency (step S103). The multiplexing unit 305 multiplexes the phase-modulated optical signal in accordance with the video signal and the laser beam based on the second oscillation frequency (step S104) The detection unit 306 performs batch reception processing (detection processing) on the multiplexed optical signal by using the photodiode (step S105). The intensity modulator 32 generates an intensity-modulated optical signal by using a laser beam for transmission (step S106).

As described above, the adjustment unit 301 acquires the feedback information indicating the difference between the transmission quality of the intensity-modulated optical signal and the required quality for each channel from the quality comparison unit 62 of the optical reception apparatus 6a. The feedback information represents a difference between the required quality and the transmission quality. The transmission quality is, for example, quality of a characteristic of a carrier-to-noise ratio (CNR). The adjustment unit 301 adjusts the power of the multi-channel signal for each channel according to the feedback information. The adjustment unit 301 gives priority to a channel having high reception power in the optical reception apparatus and reduces the power of the channel, based on the feedback information. The adjustment unit 301 may give priority to a channel having low transmission quality and increase the power of the channel, based on the feedback information. The phase modulator 303 generates a phase-modulated optical signal in accordance with the multi-channel signal, of which the voltage is adjusted, by using the laser beam based on the first oscillation frequency. The multiplexing unit 305 multiplexes the laser beam and the optical signal based on the second oscillation frequency. The detection unit 306 (modulation signal generation unit) generates a frequency modulation signal by executing detection processing on a result of multiplexing the laser beam based on the second oscillation frequency and the optical signal. The intensity modulator 32 transmits the optical signal intensity-modulated according to the frequency modulation signal, to the optical reception apparatus. The detection unit 60 (reception detection unit) converts the intensity-modulated optical signal transmitted from the intensity modulator 32 of the optical transmission apparatus 3a into a frequency modulation signal. The frequency demodulation unit 61 generates a multi-channel signal by performing demodulation processing on the frequency modulation signal. The quality comparison unit 62 (derivation unit) derives a difference between the transmission quality of the intensity-modulated optical signal and the required quality for each channel. The quality comparison unit 62 (derivation unit) transmits feedback information indicating the difference for each channel to the adjustment unit 301 of the optical transmission apparatus 3a.

As a result, an increase in a total transmission power of a multi-channel signal is suppressed, and furthermore, transmission quality of the multi-channel signal can be improved.

### First Modification Example of First Embodiment

In the first embodiment, the power of the multi-channel signal is adjusted based on the carrier-to-noise ratio (CNR). The modification example of the first embodiment is different from the first embodiment in that power of a multi-channel signal is adjusted based on a carrier-to-noise ratio and composite second order (CSO). In the modification example of the first embodiment, differences from the first embodiment will be mainly described.

The quality comparison unit 62 derives a difference between the required quality “A” and the quality “B” of the received multi-channel signal (reception signal) as a margin of quality related to the carrier-to-noise ratio, for each frequency (channel). For example, on the right side in FIG. 6, the derived difference “A-B” is represented for each channel “Ch” of the multi-channel signal.

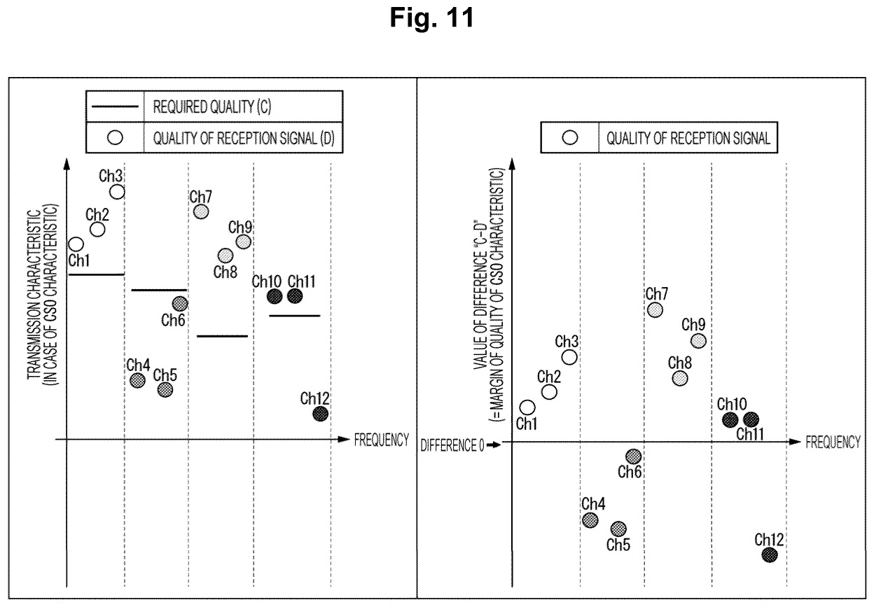

FIG. 11 is a diagram illustrating an example of a margin of quality regarding a characteristic of composite second order. On the left side in FIG. 11, the composite second order representing the transmission characteristics (quality) is represented for each channel “Ch” of the multi-channel signal. The quality comparison unit 62 derives a difference “C-D” between the required quality “C” and the quality “D” of the received multi-channel signal (reception signal) as a margin of quality related to the composite second order, for each channel. On the right side in FIG. 11, the derived difference “C-D” is represented for each channel “Ch” of the multi-channel signal.

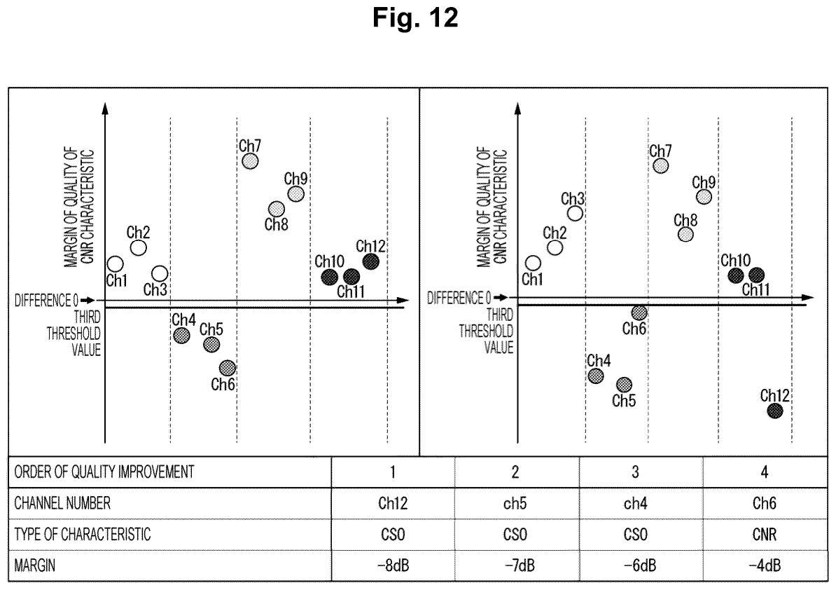

FIG. 12 is a diagram illustrating an example of an order of quality improvement. As a threshold value for detecting (extracting) a channel whose characteristics are to be improved, a third threshold value is determined in advance. The third threshold value may be, for example, “0 (dB)”, “5 (dB)”, or “−5 (dB)”. The third threshold value may be a value different for each frequency (channel). The adjustment unit 301 detects one or more channels whose characteristics need to be improved from all the channels of the multi-channel signal output from the frequency demodulation unit 61. For example, the adjustment unit 301 detects all channels in which the derived difference “C-D” is equal to or less than the third threshold value.

The adjustment unit 301 determines priority order for the channels in the order of necessity of characteristic improvement. For example, the adjustment unit 301 sets a channel with a smaller derived difference “C-D” to a higher priority. That is, the adjustment unit 301 determines a higher priority order for a channel with a smaller margin of quality. The adjustment unit 301 registers, for example, each channel and the type of the characteristic arranged in the order in which the characteristic improvement is necessary in the data table.

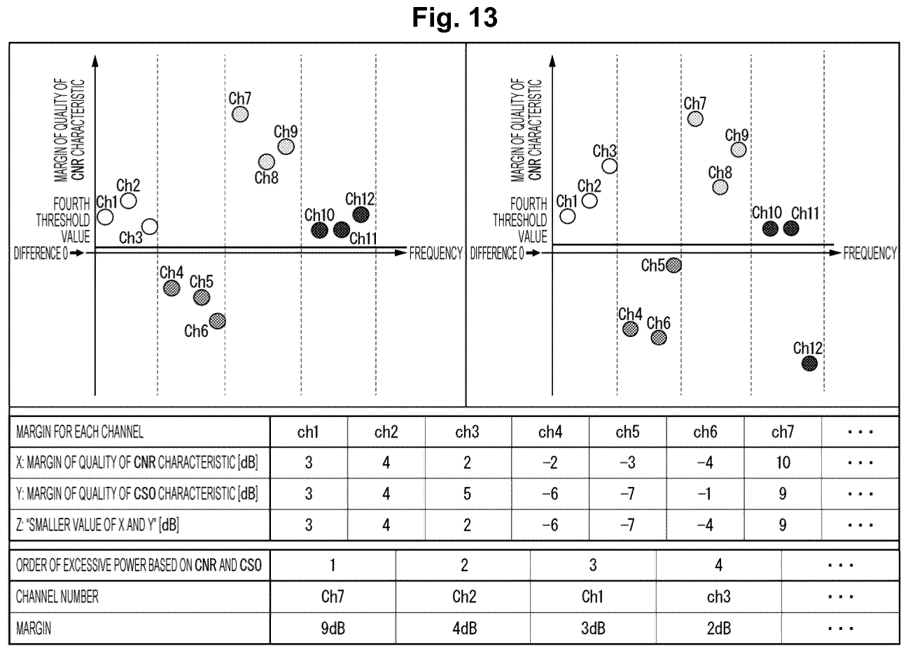

FIG. 13 is a diagram illustrating an example of an order of excessive power. The quality comparison unit 62 derives the difference “A-B” (the margin “X” of the quality of the CNR characteristic) for all the channels. The quality comparison unit 62 derives the difference “C-D” (the margin “Y” of the quality of the CSO characteristic) for all the channels.

The adjustment unit 301 compares the magnitude of the margin “X” of the quality of the CNR characteristic with the magnitude of the margin “Y” of the quality of the CSO characteristic. The adjustment unit 301 registers the smaller margin “Z” of the margin “X” and the margin “Y” in the margin data table for each channel. A weighting factor may be determined for the type of characteristic such that different types of characteristics (margins of quality) can be compared with each other using decibels as a common unit.

A fourth threshold value is determined in advance as a threshold value for detecting (extracting) a channel with excessive power. The fourth threshold value may be, for example, “0 (dB)”, “5 (dB)”, or “−5 (dB)”. The fourth threshold value may be a value different for each frequency (channel).

The adjustment unit 301 detects one or more channels with excessive power from all the channels of the multi-channel signal output from the frequency demodulation unit 61, based on the margin “Z”. For example, the adjustment unit 301 detects all channels in which the margin “z” is equal to or more than the fourth threshold value.

The adjustment unit 301 determines priority order of channels in order of excessive transmission power. For example, the adjustment unit 301 sets a channel with a larger margin “Z” of the smaller one of the margin “X” of the quality of the CNR characteristic and the margin “Y” of the quality of the CSO characteristic to have a higher priority. The adjustment unit 301 registers, for example, each channel (for example, “Ch7”, “Ch2”, “Ch1”, “Ch3”, and the like) arranged in order of excessive transmission power in the data table.

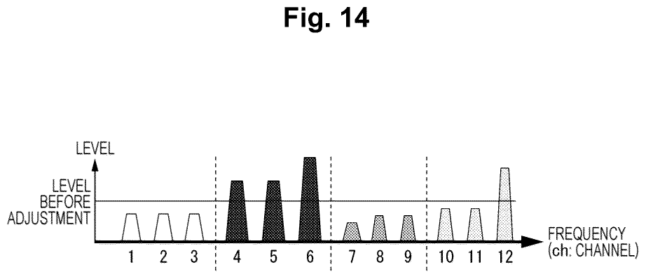

FIG. 14 is a diagram illustrating an example of a multi-channel signal after level adjustment by the adjustment unit 301. The adjustment unit 301 increases or decreases the power of the multi-channel signal before the level adjustment by the level adjustment amount each time the level adjustment processing is performed based on the feedback information. For the multi-channel signal input from the addition unit 300, the adjustment unit 301 reduces the power of each channel based on the data table (order of excessive power based on CNR and CSO) illustrated in FIG. 13 with priority given to the channel having the larger reception power in the optical reception apparatus 6a. For the multi-channel signal input from the addition unit 300, the adjustment unit 301 may increase the power of each channel by giving priority to a channel having low transmission quality based on the data table (order of quality improvement) illustrated in FIG. 12.

As a result, as an example, the power of the multi-channel signal from the channel “Ch1” to the channel “Ch3” and the power of the multi-channel signal from the channel “Ch7” to the channel “Ch 11” are smaller than the level before adjustment. Furthermore, as an example, the power of the multi-channel signal from the channel “Ch4” to the channel “Ch6” and the power of the multi-channel signal from the channel “Ch12” are larger than the level before adjustment.

As described above, the feedback information represents a difference between the required quality and the transmission quality. Transmission quality to be improved in characteristics is, for example, two or more of quality of the characteristic of a carrier-to-noise ratio (CNR), quality of the characteristic of composite second order (CSO), and quality of the characteristic of composite triple beat (CTB).

Even in a case where the transmission quality to be improved in characteristics is all of these, the adjustment processing is performed similarly to a case where the transmission quality to be improved in characteristics is two of these. That is, the adjustment unit 301 increases the transmission power of the channel having the quality with the smallest margin of the quality of the characteristic of the carrier-to-noise ratio (CNR), the quality of the characteristic of the composite second order (CSO), and the quality of the characteristic of the composite triple beat (CTB), and decreases the transmission power of the channel having the quality with the largest margin.

The transmission quality to be improved in the characteristic is not necessarily limited to the quality of the characteristic of the carrier-to-noise ratio, the quality of the characteristic of the composite second order, and the quality of the characteristic of the composite triple beat. The adjustment unit 301 may similarly perform the adjustment processing based on the quality of other transmission characteristics.

As a result, an increase in a total transmission power of a multi-channel signal is suppressed, and furthermore, transmission quality of the multi-channel signal can be improved.

### Second Modification Example of First Embodiment

The second modification of the first embodiment is different from the first embodiment in that a channel requiring characteristic improvement is not detected. In the second modification example of the first embodiment, differences from the first embodiment will be mainly described.

The adjustment unit 301 may not detect a channel requiring characteristic improvement. The adjustment unit 301 detects a channel having excessive reception power (reception level) by using, for example, the second threshold value. The adjustment unit 301 repeats level adjustment for a channel with excessive reception power until a predetermined condition for level adjustment is satisfied. Since the reception power becomes appropriate, there is a high possibility that the transmission quality of the multi-channel signal satisfies the required quality.

As described above, the adjustment unit 301 gives priority to a channel having high reception power in the optical reception apparatus 6a and reduces the power of the channel, based on the feedback information. As a result, an increase in a total transmission power of a multi-channel signal is suppressed, and furthermore, transmission quality of the multi-channel signal can be improved.

### Second Embodiment

The second embodiment is different from the first embodiment in that the optical transmission apparatus includes a quality comparison unit instead of the optical reception apparatus including the quality comparison unit. In the second embodiment, differences from the first embodiment will be mainly described.

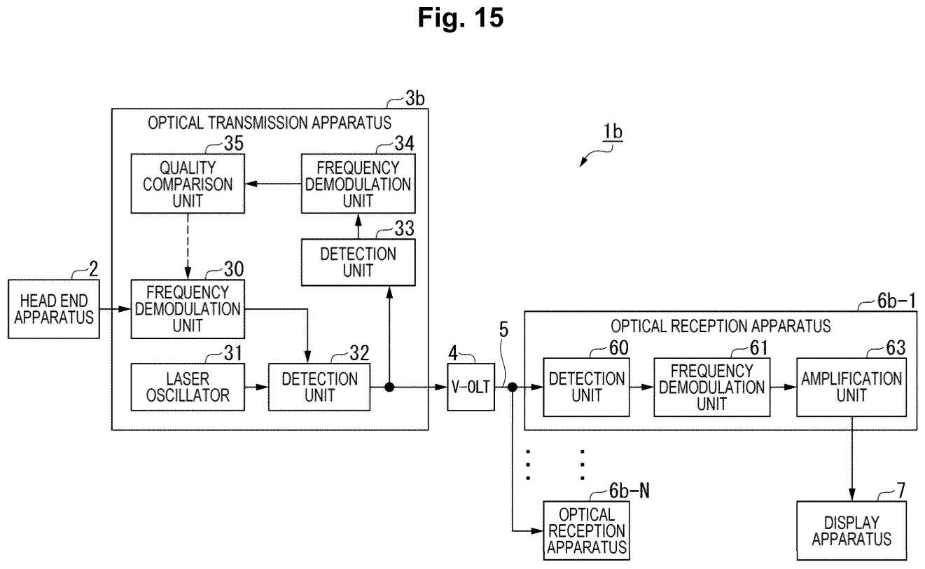

FIG. 15 is a diagram illustrating a configuration example of an optical transmission system 1b. The optical transmission system 1b is a system (optical transmission network) that transmits an optical signal. The optical transmission system 1b includes a head end apparatus 2, an optical transmission apparatus 3b, a V-OLT 4, a transmission path 5, N optical reception apparatuses 6b, and a display apparatus 7.

The optical transmission apparatus 3b is an apparatus that transmits an optical signal. The optical transmission apparatus 3b includes a frequency modulation unit 30, a laser oscillator 31, an intensity modulator 32, a detection unit 33, a frequency demodulation unit 34, and a quality comparison unit 35. The optical reception apparatus 6b is an apparatus that receives an optical signal. The optical reception apparatus 6b includes a detection unit 60, a frequency demodulation unit 61, and an amplification unit 63.

The intensity modulator 32 outputs the intensity-modulated optical signal (optical intensity modulated signal) to the detection unit 33 and the V-OLT 4. The detection unit 33 (transmission detection unit) includes a photodiode. The detection unit 33 converts the optical signal acquired from the intensity modulator 32 into a frequency modulation signal (electric signal). The frequency demodulation unit 34 generates a frequency division multiplexing signal (multi-channel signal) including a video signal by executing demodulation processing on the frequency modulation signal.

The quality comparison unit 35 compares the transmission quality of the frequency division multiplexing signal (multi-channel signal) with the required quality for each frequency (channel). The quality comparison unit 35 transmits feedback information indicating a comparison result to the frequency modulation unit 30.

The detection unit 60 converts the optical signal acquired via the transmission path 5 into a frequency modulation signal (electric signal) by detection processing (batch reception processing). The frequency demodulation unit 61 outputs the frequency division multiplexing signal to the amplification unit 63. The amplification unit 63 amplifies the power of the video signal in the frequency division multiplexing signal to a predetermined level.

As described above, the detection unit 33 (transmission detection unit) converts the intensity-modulated optical signal transmitted from the intensity modulator 32 into a frequency modulation signal. The frequency demodulation unit 34 generates a multi-channel signal by performing demodulation processing on the frequency modulation signal. The quality comparison unit 35 (derivation unit) derives a difference between the transmission quality of the intensity-modulated optical signal and the required quality for each channel. The quality comparison unit 35 transmits the feedback information to the adjustment unit 301.

As a result, for example, even in a case where the feedback line between the optical transmission apparatus 3b and the optical reception apparatus 6b cannot be used, it is possible to improve the transmission quality of the multi-channel signal while suppressing an increase in the total transmission power of the multi-channel signal. Furthermore, for example, even in a case where the feedback information cannot be fed back via the transmission path 5, it is possible to improve the transmission quality of the multi-channel signal while suppressing an increase in the total transmission power of the multi-channel signal.

Some or all of the functional units of the optical transmission systems 1a and 1b are realized as software by causing a processor such as a central processing unit (CPU) to execute a program stored in a storage device including a non-volatile recording medium (non-transitory recording medium) and a memory. The program may be recorded on a computer-readable recording medium. The computer-readable recording medium is, for example, a portable medium such as a flexible disk, a magneto-optical disc, a read-only memory (ROM), or a compact disc read-only memory (CD-ROM), or a non-transitory recording medium such as a storage device such as a hard disk provided in a computer system.

Some or all of the functional units of the optical transmission systems 1a and 1b may be realized by using hardware including an electronic circuit (electronic circuit or circuitry) in which, for example, a large scale integrated circuit (LSI), an application specific integrated circuit (ASIC), a programmable logic device (PLD), a field programmable gate array (FPGA), or the like is used.

The embodiments may be combined.

Although the embodiments of the present invention have been described in detail with reference to the drawings so far, specific configurations are not limited to these embodiments, and include designs and the like without departing from the spirit of the present invention.

### INDUSTRIAL APPLICABILITY

The present invention is applicable to a video distribution system.

### REFERENCE SIGNS LIST

1a, 1b Optical transmission system
2 Head end apparatus
3 Optical transmission apparatus

### 4 V-OLT

5 Transmission path
6 Optical reception apparatus
7 Display apparatus
30 Frequency modulation unit
31 Laser oscillator
32 Intensity modulator
33 Detection unit
34 Frequency demodulation unit
35 Quality comparison unit
60 Detection unit
61 Frequency demodulation unit
62 Quality comparison unit
63 Amplification unit
100 Frequency modulation unit
101 First laser oscillator
102 Second laser oscillator
103 Phase modulator
104 Multiplexing unit
105 Detection unit
110 Frequency modulation unit
111 First laser oscillator
112 Second laser oscillator
113 Addition unit
114 Phase modulator
115 Multiplexing unit
116 Detection unit
300 Addition unit
301 Adjustment unit
302 First laser oscillator
303 Phase modulator
304 Second laser oscillator
305 Multiplexing unit
306 Detection unit

1. An optical reception apparatus comprising:
a reception detection unit that converts an intensity-modulated optical signal transmitted from an optical transmission apparatus into a frequency modulation signal;
a frequency demodulation unit that generates a multi-channel signal by performing demodulation processing on the frequency modulation signal; and
a derivation unit that derives, for each of a channel, a difference between transmission quality and required quality of the intensity-modulated optical signal, and transmits feedback information indicating the difference for each of the channel to the optical transmission apparatus.

2. An optical transmission apparatus comprising:
an adjustment unit that acquires feedback information indicating a difference between transmission quality of an intensity-modulated optical signal and required quality for each of a channel from an optical reception apparatus, and adjusts power of a multi-channel signal for each of the channel according to the feedback information;
a phase modulator that generates an optical signal phase-modulated according to the multi-channel signal the power of which has been adjusted, by using a laser beam based on a first oscillation frequency;
a multiplexing unit that multiplexes a laser beam based on a second oscillation frequency and the optical signal;
a modulation signal generation unit that generates a frequency modulation signal by performing detection processing on a result of multiplexing the laser beam based on the second oscillation frequency and the optical signal; and
an intensity modulator that transmits the intensity-modulated optical signal, according to the frequency modulation signal, to the optical reception apparatus.

3. The optical transmission apparatus according to claim 2,
wherein the adjustment unit gives priority to the channel having high reception power in the optical reception apparatus and reduces the power of the channel, based on the feedback information.

4. The optical transmission apparatus according to claim 3,
wherein the adjustment unit gives priority to the channel having low transmission quality and increase the power of the channel, based on the feedback information.

5. The optical transmission apparatus according to claim 2, further comprising:
a transmission detection unit that converts the intensity-modulated optical signal transmitted from the intensity modulator into the frequency modulation signal;
a frequency demodulation unit that generates the multi-channel signal by performing demodulation processing on the frequency modulation signal; and
a derivation unit that derives, for each of the channel, a difference between transmission quality and required quality of the intensity-modulated optical signal, and transmits the feedback information to the adjustment unit.

6. An optical transmission system comprising:
an adjustment unit that acquires feedback information representing a difference between transmission quality of an intensity-modulated optical signal and required quality for each of a channel from an optical reception apparatus, and adjusts power of a multi-channel signal for each of the channel according to the feedback information;
a phase modulator that generates an optical signal phase-modulated according to the multi-channel signal the power of which has been adjusted, by using a laser beam based on a first oscillation frequency;
a multiplexing unit that multiplexes a laser beam based on a second oscillation frequency and the optical signal;
a modulation signal generation unit that generates a frequency modulation signal by executing detection processing on a result of multiplexing the laser beam based on the second oscillation frequency and the optical signal;
an intensity modulator that transmits the intensity-modulated optical signal according to the frequency modulation signal, to the optical reception apparatus;
a reception detection unit that converts the intensity-modulated optical signal transmitted from the intensity modulator into the frequency modulation signal;
a frequency demodulation unit that generates the multi-channel signal by performing demodulation processing on the frequency modulation signal; and
a derivation unit that derives a difference between transmission quality and required quality of the intensity-modulated optical signal for each of the channel and transmits the feedback information to the adjustment unit.

7. (canceled)

8. (canceled)
